(19) United States
(12) Patent Application Publication
(10) Pub. No.: US 2016/0301801 A1
(43) Pub. Date: Oct. 13, 2016

(54) SYSTEM AND METHOD FOR DEVICE AVAILABILITY SIGNALING

(71) Applicant: MYSTATE MOBILE (2014) LTD., Petah Tikvah (IL)

(72) Inventors: Ami HANYA, Kfar Tapuach (IL); Oshry MAIMON, Shiloh (IL); Assaf PNEY-EL, Shiloh (IL); Rony Haim OHAYON, Rehovot (IL)

(21) Appl. No.: 14/896,869

(22) PCT Filed: Sep. 16, 2015
(86) PCT No.: PCT/IL2015/050940

§ 371 Date: Dec. 8, 2015

Related U.S. Application Data
(60) Provisional application No. 62/050,223, filed on Sep. 15, 2014.

(51) Int. Cl. H04M 3/42; H04M 1/2745; H04W 4/16

(52) U.S. Cl. CPC H04M 3/42365; H04W 4/16; H04M 1/2745

(57) ABSTRACT

A system and method for receiving and storing telephone status data (busy, off, free) of a contact, and transmitting such data over a data network to telephones that include such contact on contact list. An indication of the status of the contact may appear in association with the contact's other data on the contact list so that a user of the telephone storing the contact can determine if the contact is available without dialing the contact.

### BACKGROUND OF THE INVENTION

Typically the availability status of a device to accept a network signal such as a telephone call or cellular telephone call is communicated to a user of the network upon the delivery of a signal by such user to initiate communication with such device. For example, if a first user of a cellular network wishes to initiate a telephone conversation with a second user of the cellular network, the first user will typically attempt to place a call to the second user over the network. The network will attempt to ring or signal the second user, and send a signal back to the first user that the second user is, for example, available for a call, busy on another call, or otherwise unavailable for a call. Typically the first user must initiate a signal over the network, i.e., dial a call, to determine the availability of the second user. Such initiation may be frustrating and wasteful of time and resources.

### SUMMARY OF THE INVENTION

In one aspect, the invention is a method for providing availability status data for a plurality of identified mobile cellular telephone devices represented on a contact list stored on a first mobile cellular telephone device. The method comprises storing on a remote memory, an association of said first mobile cellular telephone device with at least one of a plurality of identified mobile cellular telephone devices represented on said contact list. The method further comprises transmitting, over a data network, to said first mobile cellular telephone device, an availability status for at least one of said plurality of identified mobile cellular telephone devices included on the contact list; and displaying an indication of availability status in association with a representation on said contact list of said at least one of said plurality of identified mobile cellular telephone devices.

In embodiments, transmitting involves transmitting over the data network on a periodic basis said availability status for a first and for a second of said plurality of identified mobile cellular telephone devices represented on the contact list, said first and said second identified mobile cellular telephone devices associated with devices frequently called from said first mobile cellular telephone device; and not transmitting an availability status of a third of said plurality of identified mobile cellular telephone devices represented on said contact list, said third identified mobile telephone device associated with mobile cellular telephone devices less frequently called from said first mobile cellular telephone device.

In another aspect the invention is a method of presenting a caller with a busy signal, comprising: storing, on a memory of a calling cellular telephone and during a period prior to the initiation of a call from said calling telephone, an availability status of a called cellular telephone; receiving a signal to initiate the call from the calling telephone to the called telephone; retrieving from memory the availability status of a called cellular telephone; and in response to said retrieved availability status, presenting a busy signal to the caller.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a schematic drawing of a system in accordance with an embodiment of the invention;

FIG. 2 is a list of contacts of a device that may indicate a status of some or all of the contacts on a contact list in accordance with an embodiment of the invention;

FIG. 3 is a flow diagram of a method in accordance with an embodiment of the invention; and

FIG. 4 is a flow diagram of a method of presenting a caller with a busy signal in accordance with an embodiment of the invention.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other non-transitory storage medium that may store instructions to perform operations and/or processes. Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. The term set when used herein may include one or more items. Unless explicitly stated, the method embodiments described herein are not constrained to a particular order or sequence. Additionally, some of the described method embodiments or elements thereof can occur or be performed simultaneously, at the same point in time, or concurrently.

The processes and functions presented herein are not inherently related to any particular computer, network or other apparatus. Embodiments of the invention described herein are not described with reference to any particular programming language, machine code, etc. It will be appreciated that a variety of programming languages, network systems, protocols or hardware configurations may be used to implement the teachings of the embodiments of the invention as described herein. In some embodiments, one or more methods of embodiments of the invention may be stored on an article such as a memory device, where such instructions upon execution by for example one or more processors results in a method of an embodiment of the invention. In some embodiments, one or more components of a system may be associated with other components by way of a wired or wireless network. For example one or more memory units and one or more processors may be in separate locations and connected by wired or wireless communications to execute such instructions.

As used in this application, the term ‘call’ may refer standard cellular telephone call or to a voice over IP call.

As used in this application, the term ‘contact’ or ‘contact list’ may, in addition to its regular meaning, include an indication or identification of a second device or person that is stored on a first device. In some embodiments, the term contact list may include a list of names and or contact information such as telephone numbers or other unique identifiers, that may be stored on a mobile communication device, onto which other contacts may be added and from which a user of such device may activate a telephone call to the telephone number associated with a listed contact.

As used in this application, a cellular network may in addition to its regular meaning, include or refer to a switching network, a Global System for Mobile Communications (GSM), 3G, 4G, LTE/LTE advanced or other cellular network. A data network or TCP/IP network such as for example the Internet, may refer to a data network that may operate through the routing over a network of data in packets. Such data network may transmit data over a wired network, a wireless network or a combination of wired and wireless networks. A single device such as a mobile cellular telephone device may at various times utilize a cellular or switching network and/or a data network.

As used in this application, and in addition to its regular meaning, a unique identifier on a cellular network, may refer to a telephone number of a cellular telephone, a SIM number or identifier, or other unique identifier by which a device is recognized or identified on a cellular network.

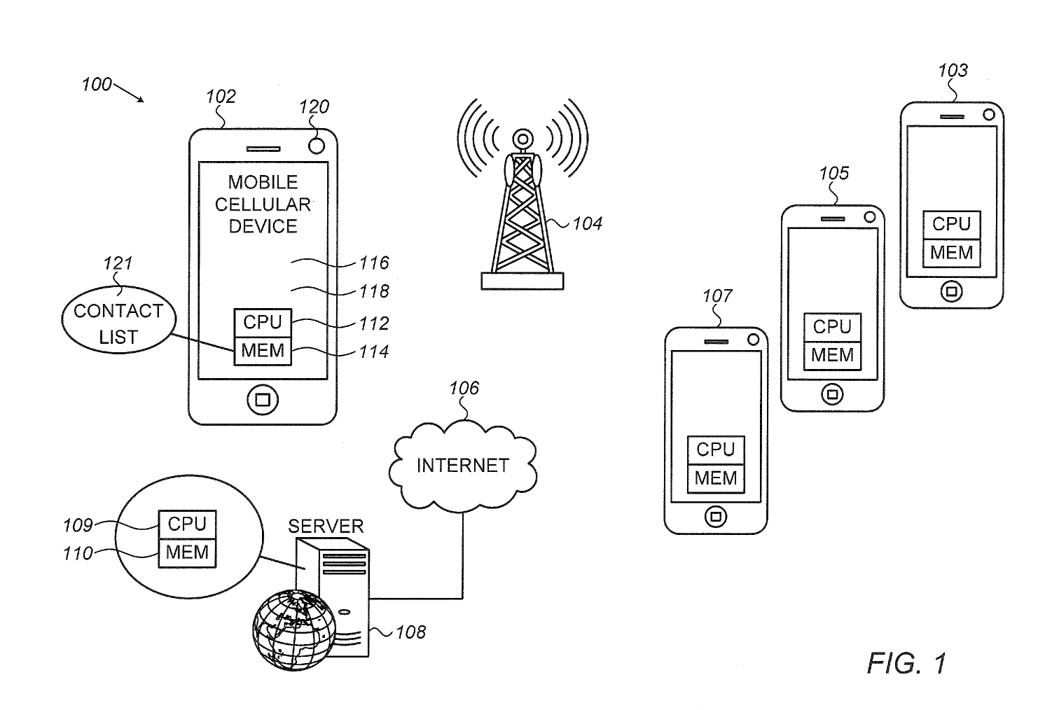

Reference is made to FIG. 1, a system in accordance with an embodiment of the invention. Embodiments of the invention may include a system 100 including a mobile device(s) 102, 103, 105, 107 in communication with a network, such as a cellular network 104, the Internet 106 and/or other networks, one or more servers 108 such as application servers that may include one or more processors 109, one or more databases and/or information storage devices or memories 110, some or all of which may be in communication with network 104, 106. Device 102 may be or include a cellular telephone, smart phone, tablet computer, laptop computer, network telephone or other device that may communicate over for example wired and/or wireless networks. A device 102 may include one or more processors 112, one or more memory 114 units, one or more sensors 120, such as physical sensors (accelerometers, motion sensors, etc.), software-based sensors or device sensors (ringer on/ringer off, screen on/screen off, device on/device off), an electronic display 116 and an input device 118 such as for example a keyboard, microphone, touch screen or other input device. Embodiments of the invention may include machine-readable executable code contained in a non-transitory storage medium for a computing device, wherein the executable code, when executed by the computing device, causes the computing device to perform a method of the invention. In some embodiments, one or more of the functions performed by processor 109 may be performed by more than one processor, which may be housed remotely from one another. In some embodiments, data storage or memories 110 may be housed remotely from one or more devices, and data may be stored in more than one memory 110.

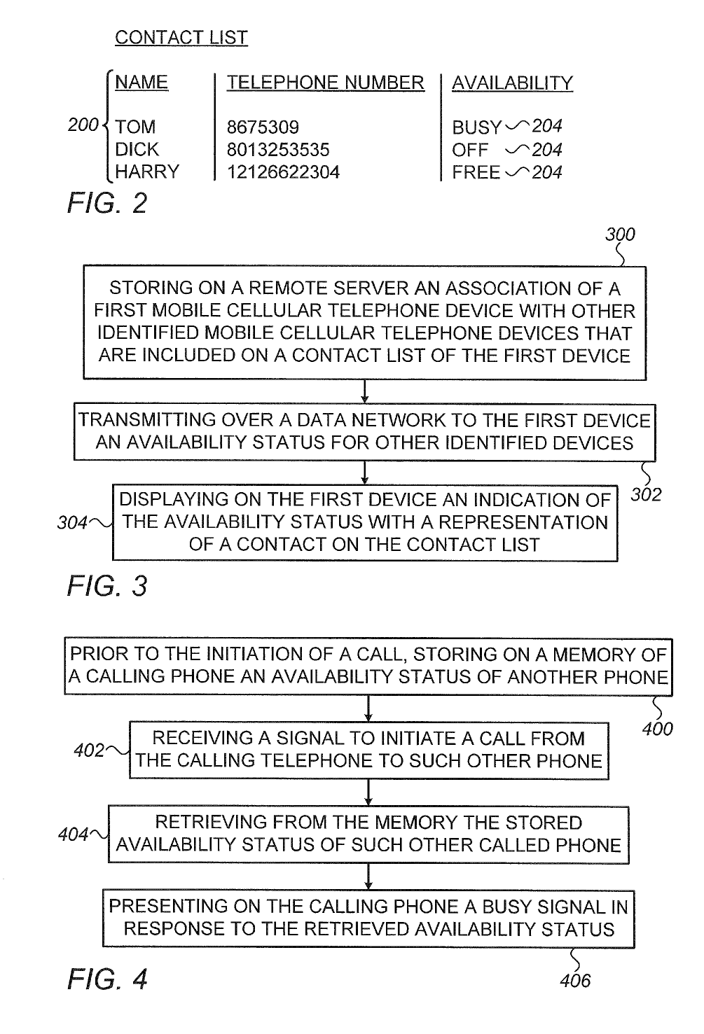

In operation, a user of a device 102 may input a status of the device 102 or of the user by way of for example input device 118, or such status may be inputted automatically by a sensor 120 associated with device 102. Such a delivery of status information may be initiated by a user of device 102, by processor 112 associated with device 102, by a processor 109 associated with server 108, or by other processors. A status or indication of such status may be transmitted from device 102 by way of network 104 or by some other network or signal to for example server 108 on for example a periodic basis or in response to a trigger or signal. Server 108 may collect status information from one or more devices 102 and may store such status information in association with an identifier of device 102. For example, a telephone number, SIM number or other unique identifier of device 102 may be stored in processor 112, delivered to server 108 and stored in memory 110. A status information or indication may be delivered for example by way of network 104 to memory 110, and associated with the unique identifier of device 102 that may also be stored in or associated with memory 110. Unique identifiers of other devices 103, 105 may also be associated with device 102 as being authorized to see or gain access to status information of device 102 that may be stored on memory 110, such that a group 121 of authorized devices may be associated or created on for example memory 110 as having access to status information of one or more members of such group 121 as is described in FIG. 2 below. In some embodiments, members of a group 121 to which a user or device belongs may be shown or made available for display on display 116. For example, an application running on device 102 may show or list a group 121 of devices or users, as well as an indication of a status of one or more of such users or devices 103 and 105. The application may be available for installation on device 102 (for example, a “caller” device) and on device 103 (for example, a “callee” device). In some embodiments a consent or permission from for example a user of device 102 or 103 may be required by system 100 in order for a device 102 or user to join a group 121 or otherwise to be permitted to receive or send status information from another device 103.

A status information may be or include data such as ‘available to take a call’, ‘busy on a call’, ‘available for text messages only’, ‘phone off’, ‘ringer off’, ‘on-silent’, ‘on-vibrate’, ‘please call’, ‘in a meeting’, ‘charging battery’, ‘low battery’, ‘driving’, ‘different time zone and relevant time indication’, ‘driving’, ‘running’, ‘watching video (Youtube)’, ‘taking video movie’, or other status that may be defined for example by a user, or automatic indication made by the software on the mobile device 102, or may be provided for selection by way of for example a menu that may appear on display 116. In some embodiments, an entry on a contact list may expand when it is touched, such as by a drop down memory or expanded window, to show more than one status line. For example, a first line may show ‘on a call’ or ‘OFF’, and a second line may show one or more preferred alternate messaging mediums by which the caller may send a message or otherwise contact the person. One or more of such statuses may be associated with for example an icon, color (green, yellow, red, check, X, ‘?’ or others, etc.) or other indications as may appear on display 116, as may be selected by a user or provided by server 108. In some embodiments, a status may be customized by a user as an image, color, icon, recorded message, photo or other. A status may be customized as “unstatus” for those who do not want to indicate their status at a particular time to one, some or all other users of the system. Other statuses may be used, and statuses may be imported for example automatically from for example other social network applications or calendar applications.

In some embodiments, one or more states may be detected automatically by for example a sensor in the device itself or a signal sent automatically by the device to the system. Such automatic detection states may include, ‘I'm busy on a call’, ‘OFF’, ‘SILENT’ ‘Different time zone’, etc. Other states may be dictated or inputted by the user and may appear as ‘In a Meeting’, ‘Went to bed’, etc. Still other data may include a preference for alternate message mediums by which others may send messages to the person. In some embodiments, automated states may be gleaned by for example other devices or systems. For example, a calendar on a person's computer that is synced with his phone may detect that the person is to be in a meeting from 2 PM to 3 PM. The calendar may automatically send a signal to the system 100 to change the state of the person to ‘In a Meeting’ at such time period.

In some embodiments, a status may be applicable to a particular user or group of users. For example, a status may be indicated as ‘available’ to a group of users that may include a spouse or child of a user, but may be indicated as ‘unavailable’ to business associates or friends. Each of such groups may be defined by a user or a group of users.

On an occasional, periodic or initiated basis, a signal may be sent to device 102 by for example server 108 by way of network 104. Such signal may include for example, updated status information of one or more users or devices 103 that are in a group 121 associated with device 102. Such signal may update or change the status indication, color, message or icon that is presented on display 116 of device 102 so that the list of the group 121 is presented on display 116, the updated status information is displayed.

In some embodiments, a user or device 102 may request to get the updated status of other device(s) 103, 105. For example, a device 102 may issue a signal to server 108 requesting that it be provided with an updated status of one or more other devices 103, 105, 107.

In some embodiments, when a call is initiated from device 102 (the “caller”) to device 103 (the “callee”) which is also connected to the system or has the installed application, a pop-up or overlay screen may appear on the dialing screen of the caller. The system, or for example a memory of device 102 may detect that caller is calling the callee device 103, and may display an availability status of the callee device 103 on a screen of the caller's device 102. Such overlay screen may be shown even if the caller did not initiate the call from the application. For example, if the caller initiates a call to callee device 103, a memory of the caller's telephone which had already received status data of the callee from system 100 may, before the call is completed or a busy signal is received, present on a screen of the caller's telephone, a status of the callee that may include a ‘busy’ or ‘on a call’ indication or ‘off’, as well as alternative messaging medium by which the caller may send a message or information to the callee. In some embodiments, the state of device 103 may have been pushed or transmitted by server 108 to the caller in a prior period before a call to device 103 was initiated or on a periodic basis, so that the state or status of device 103 is known to device 102 even before a call is initiated from device 102 to device 103.

In some embodiments, if a device 107 that does not have or is not running a version of the application or system 100, calls a device 102 that does have the system or application, and receives a busy signal about device 102 or other signal that the call was not completed, a version of the system may send for example an SMS or other message to device 107 with information about the state of device 102. Device 107 can also send later an SMS message indicating that 102 is available (upon call completion or change in status from off to on). Such message may also include an invitation for device 107 to run or sign up for the system.

In some embodiments, server 108 and memory 110 may request a status setting from device 102 on a regular or periodic basis, and may store an indication of such status setting in memory 110.

In some embodiments a first device 102 may permit or authorize a system to allow a second device 103 to see or receive indications of the availability status of the device 102.

Reference is made to FIG. 2, a list of contacts of a device that may indicate a status of some or all of the contacts in accordance with an embodiment of the invention. In some embodiments, device 102 may for example store a list of contacts 200 that may include names, phone numbers and other data of persons or devices that are frequently or have in the past been called from device 102 or that are on the contact list stored in device 102. In some embodiments, server 108 may update some or all of the names or numbers on list of contacts 200 to show a status of some or all of such contacts. The indication of such status may be shown on an on-going basis for some or all of such contacts 200, and the status may be shown on for example a contact list at all times. In some embodiments, the status of such contacts may include ‘busy’, ‘free’, ‘on silent’, ‘in a meeting’, ‘on vibrate’, ‘no signal’ or other status settings that may be set manually by a user of the device representing the contact, or that may be detected automatically by a network or by a sensor in the device represented by the contact or by the application which is running on 102.

In some embodiments, a status indicator 204 of a contact 200 may be updated in real time, on a periodic basis, upon a trigger action by for example a user of a device or using a mixture of some or all of such events. For example, an indication of a status of a number or device may be updated on a continuous or near continuous basis by server 108 and memory 110. Such continuous updating may be executed by notices of changes of status that are sent by device 103 or 105 to server 108 and memory 110. Server 108 may update a status indicator on a contact list of device 102 in various ways. For example, one or more contacts 200 on contact list whose numbers are frequently dialed by device 102 may be updated on a regular basis on device 102 by server 108. For example, server 108 or device 102 may keep a log or record of the twenty or more contacts 200 on contact list of device 102 that are called most frequently in for example one or more of a given period or over a long period. A status indicator of such top twenty numbers may be updated on a near continuous or periodic basis. A rest of the contacts of group 121 may be updated on device 102 by server 108 when for example the name of the contact is inputted into a search function of device 102, where such inputting constitutes a signal or request for an updating of one or more contacts. For example, when a search function associated with a contact list receives the letters ‘SMI’, a signal may be sent from device 102 to server 108, which may update the contact status indicators of all of the names on contact list that start with the letter S, with SM or with SMI. Alternatively or in addition, a signal may be sent from device 102 to server 108 when a user of device 102 pages or scrolls through a contact list. Such signal may include for example all or some of the contacts that appear on a screen shot of the pages that are being browsed by the user. In response to such signals, server 108 may send an update of the status of the contacts that appear on the pages in the screen shots that are being browsed or the names of the contacts that are being searched. Such update may change or refresh the status indicators of the contacts whose letters match those that are input in the search function or those contacts that appear in the pages of the contact list that is being browsed. In some embodiments, a contact indicator may be updated within approximately one second from the initiation of an action by a user, so that a user will not or will barely realize a delay in receiving an update of the status indicator of the contact.

In some embodiments, a command may be accepted to update a status of some or all of the members of a contact list or groups on a contact list at certain times or frequencies, such as for example only when the device is fully charged or plugged into a power source, or only when the device is associated with a network over a WiFi or other free connection service.

The mixing or combination of continuous updating of frequently used contacts on a list of contacts by pushing data from server 108 to device 102, and occasional or periodic updating of status indicators for less frequently used or dialed contacts on a pull basis, upon or in response to a signal from device 102 to server 108, may allow a minimizing or great reduction in an amount of data that is transferred from server 108 to device 102 on a regular basis, while still maintaining a fast response time to a user's request for updated status indicators. Such a process may also allow a continuous display of status indicators of all or most of the contacts on a contact list at all times, with an update made to selected status indicators that have changed between requests or most recent past updates. For example, a memory on device 102 or memory 110 may store or cache a time of a most recent update of status indicators to device 102, and a list of status indicators that have changed between a current update time and such last time. Data transferred to device 102 in a current update may be limited to the contacts statuses that have changed during such period, and may be further limited to changed status indicators for those contacts that are the subject of a search or a screen shot of page of contacts being browsed. An amount of data required to be transmitted from server 108 to device 102 may also be reduced by storing on device 102 a reference number associated with a status, and by transmitting only the reference number as an indicator of the status to be displayed with the associated identifier of a name on a contact list. In some embodiments, updates or changes to status indicators may be delivered to device 102 in an encoded form, and such delivered data may be encoded on device 102 for translation into changes in status indicators.

In some embodiments a frequency of calls to a contact may be measured both over for example a most recent period (e.g., calls made to a plumber working in the house) as well as over a longer period (e.g., calls made to a spouse). In some embodiments, a method of the invention may track a frequency of calls to or from a contact and may automatically add or remove a contact from a list of frequent contacts.

In some embodiments, statuses of a contact whose name or identifier appears on a contact list may be updated on an automatic basis or in response to an input or action by such contact. For example, a user of device 103 may take an action or send a signal to server 108 that he is putting his status on ‘do not disturb’/red. Alternatively or in addition, server 108 may receive a signal from for example a network operating system that device 105 is no longer in contact with a network, and such signal may automatically trigger a change in a status of device 105 as is stored on server 108 or memory 110.

In some embodiments, a user may issue a command to alert him through a signal from device 102 of a change in a status of one or more contacts, referred to as a ‘critical status indication’. For example, a user of device 102 may see that device 103 on his contact list is shown with a ‘busy’ or ‘off’ indicator. The user of device 102 may signal server 108 to alert him by way of device 102 (such action called a ‘CRUNCH’ or ‘PARK on the LINE’) when a status of device 103 changes or changes to ‘available’ or on or ‘please call me now’. Such signal may also be provided to 103 to indicate that 102 is attempting to contact 103. Upon such change in a status of device 103, a signal may be sent to device 102 or a call may be executed between device 102 and device 103, or an indication such as a beep or alert may be sent to device 102 that 103 is available and a call may then be made between device 102 and device 103. In some embodiments, if a status of device 102 is busy, or on a call, the system 100 may present a preferred action of CRUNCH to device 103, as a preferred way of contacting device 102. The ‘busy’ or ‘off’ signal is relevant for both cellular circuit switch as well as packet switch voice calls. The same applies for the CRUNCH action. In some embodiments, if a device 103 is not enrolled in a method or application such as the one described herein, then a short message system (SMS) may be sent to such device upon such change in status. For example, if Mark (who does not have the application) tries to reach Jeff (who does have the application), a function of the application may send an SMS to Mark with an indication of Jeff's status as is saved on a server. Such SMS may in some embodiments include a link to allow Mark to download the application to his phone. In response to the SMS or some other signal, Mark may request that the system for example alert Jeff that Mark tried to contact him, connect him to Jeff or otherwise alert him when Jeff becomes free or available to take a call.

Reference is made to FIG. 3, a flow diagram in accordance with an embodiment of the invention. A method of an embodiment of the invention may include providing availability status data for various mobile cellular telephone devices that are represented or listed on a contact list of a user's device such as a user's mobile cellular telephone device. The representations on such list may include a name, other contact information and one or more unique numbers of strings of numbers and letters (such as a telephone number, SIM number or other identifiers) as may be used on a cellular network for identifying such devices to the cellular network. One or more of such various devices on the contact list may also be represented or associated with unique identifiers (such as a MAC address) that may be used for identifying the device to the data network.

As is shown in Block 300, in some embodiments, the method may include storing on a remote memory such as a memory of a remote server, an association of the user's mobile cellular telephone device with some or all of the contacts on the contact list of the user's mobile phone. Some or all of such contacts may include telephone number information, and other unique identifiers. In some embodiments, such contacts or unique identifiers of such contacts may be or may have been transmitted to the remote server over the data network, when for example the user downloaded or otherwise activated the system, when the user updates his contact list or at other times. In some embodiments, the remote memory may store an association of the user's unique identification number with the unique identification numbers of one or more of the contacts on the contact list.

In some embodiments, a device that is associated with one or more of the contacts on the user's contact list may transmit to one or more remote memories that are associated with the remote memory described above, an availability status of such device, and such availability status may be stored in association with the contact.

As is shown in Block 302, in some embodiments, at various times, such as on a continuous, periodic or intermittent basis, the system may transmit over the data network from one or more of the remote memories to the user's device, an indication of the availability status for one or more of the contacts that appear on the user's contact list. Such transmitted availability status of the one or more contacts on the user's contact list may be stored in association with the respective contact, such that an indication of such availability status is stored on the user's mobile device, even before the user requests data about such availability status of such contact. In some embodiments, one or more availability statuses may be transmitted from the device that is listed on a contact list to the user's device. In such an embodiment, the user's device would collect availability status directly from telephones of those devices that are on his contact list, rather than from a remote server. Such peer-to-peer transmission of data may reduce the system's reliance on a server to collect availability status.

As is shown in Block 304, in some embodiments, a method may include displaying an indication of the availability status of one or more of the contacts on the contact list in association with a representation of the contact on the contact list. For example, a contact may be represented on a display screen of the user's telephone by a name, and such name may be associated with one or more of the contact's device's MAC number, SIM number, telephone number of other identifiers that may be stored in or in association with the contact on the contact list. A visible representation of the availability status may be displayed near or in association with the visible representation of the contact on the contact list. For example, a green dot or other icon may be shown next to the name of a contact on the contact list to indicate that the device is ‘on’ if the contact is available for a call on the cellular network. A red dot or other icon, color or indication may be shown next to the name of a contact on the contact list to indicate that the device is ‘off’ if the contact is unavailable for a call on the cellular network, as a result of the contact's phone being engaged on the cellular network, or for some other reason that is not related to the operation of the cellular network.

In some embodiments, availability status of contacts may be transmitted over a data network to the user's device, and such availability status may relate to the availability of the device of the contact to accept a call on a cellular network.

In some embodiments, it may not be desirable to continuously update availability status of all contacts that appear on a contact list. Such updating may therefore be done periodically, and/or to less than all of the contacts. For example, a system may track and identify some or all of the frequently called contacts, and transmit availability status for such frequent contacts at a first rate, frequency or periodicity, and may transmit availability status data for other, less frequently called contacts at a second rate, frequency or periodicity. In some embodiments, availability status data may be transmitted to a user's device when the user searches his contact list. For example, status availability data for contacts whose names begin with an S, may be transferred when the user searches for contacts whose names begin with an S. Other indication of a selection of contacts may trigger the transfer of some or all of the contacts that are identified as possibly being searched for by the user on his contact list.

In some embodiments, the system may receive a signal including an availability status from the device(s) of one or more of the contacts, and such signal may include a status of such device as was collected automatically by a sensor in or associated with the contact's device. For example, a sensor in the contact's device may detect that the device is off, that the device is engaged on a telephone call, that the device is located in a remote time zone, that the device is on a silent setting or other such status as may be detected by a sensor. A signal from the device, according to this embodiment of the system, may include an indication of such automatically collected status. In some embodiments, a user of the device may input or create and input his own availability status and such status or a representation of the status may appear in association with the contact on the user's contact list. Such inputted status may include for example “Went to Bed”, “Bad Day—Please Call”, “On my way home”, “Job Done” or other status, data or message, and such may appear in association with the name of the contact on the user's contact list. Such text messages are entered manually by the user (as opposed to being generated automatically). Availability statuses may include one or more of ‘available for a call’, ‘busy on a call’, ‘phone off’, ‘ringer off’, ‘on-silent’, ‘on-vibrate’, ‘please call’, ‘in a meeting’, and ‘in a different time zone’.

In some embodiments, a memory associated with the system may receive over the data network a first a unique identifier for a contact, as such identifier is used for the cellular network and a second unique identifier for the contact as such second unique identifier is used on the data network. Such two or more unique identifiers may be associated with the contact.

In some embodiments, a device of a contact may issue a signal for the system not to transmit his availability status to one or more users, or to transmit different or various availability statuses to each of various users.

In some embodiments, the system may indicate or display that a certain contact is unavailable for a call. The user may issue a signal to the system to alert the user at the time when the status of the contact has changed to available, and when the users' device is also available. An embodiment of the system may initiate or place the call between the user and the contact at such time. In some embodiments, an availability status of a contact may change from a first status to a second status, and such changed status may be transmitted to the user's device in real-time or within a short period of time (such as several seconds) of such change of status, and the indication or representation of such status of the contact may be changed on the user's display.

In some embodiments, a TCP/IP network may collect over a data channel information on a state of the device, and may transmit such state information to one or more other devices. When a call is made by a device on the circuit switch channel or packet switch, the information received from the data network may be presented to the user even before the voice call is initiated over the cellular circuit switch channel or packet switch. Information that was collected from the data channel may be precede interrupt or pre-empt the data that is made available to the user from the voice channel. For example, a busy signal may be returned to a device over a voice channel if an initiated call is not completed because the other device is engaged. In some embodiments, a busy signal or other indication of unavailability may be collected from the data channel and pushed to a device even before a call is initiated on the voice channel.

Reference is made to FIG. 4, a method of presenting a caller with a busy signal in accordance with an embodiment of the invention. Embodiments of the invention may include a method for presenting a caller with a busy or an indication that a called telephone is not available to take a call. In Block 400 a memory of the calling cellular telephone may during a period prior to the initiation of a call from the calling telephone, store an availability status of the called cellular telephone. In some embodiments the availability status of the called telephone may have been transmitted over for example a data network to the calling telephone, and associated with a unique identifier of the called telephone as may be stored on a contact list of the calling telephone. In Block 402, a processor in the calling telephone may receive a signal to initiate a call to the called telephone, such call to be executed over a cellular network. In Block 404, a processor of the calling telephone may retrieve from a memory of the calling telephone the stored availability status of the called telephone. In Block 406, in response to the retrieved availability status of the called telephone, the processor may issue a signal to presenting to a user of the calling telephone a busy signal. Such presentation may be made by way of a standard audio busy signal, or by way of a display on a display screen of the calling telephone.

In some embodiments, the memory of the calling telephone may also store a preferred alternative medium for contacting the called telephone, such as by way of SMS, email or through other medium, and such preferred medium may be displayed or conveyed to the user of the calling telephone. In some embodiments, the preferred alternative medium may have been selected by a user of the called telephone and input to the called telephone before such alternative medium was transmitted to the calling telephone.

1. A method for providing availability status data for a plurality of identified mobile cellular telephone devices represented on a contact list, said contact list stored on a first mobile cellular telephone device, the method comprising:
storing on a remote memory, an association of said first mobile cellular telephone device with at least one of said plurality of identified mobile cellular telephone devices represented on said contact list;
transmitting, over a data network, from said remote memory to said first mobile cellular telephone device, an availability status for said at least one of said plurality of identified mobile cellular telephone devices included on said contact list; and
displaying an indication of said availability status in association with a representation on said contact list of said at least one of said plurality of identified mobile cellular telephone devices.

2. The method as in claim 1, wherein said transmitting comprises transmitting an availability status for a telephone call, said call on a cellular network.

3. The method as in claim 1, wherein said transmitting comprises:
transmitting over said data network on a periodic basis said availability status for a first and for a second of said plurality of identified mobile cellular telephone devices represented on said contact list, said first and said second identified associated with mobile cellular telephone devices frequently called from said first mobile cellular telephone device; and
not transmitting an availability status of a third of said plurality of identified mobile cellular telephone devices represented on said contact list, said third identified associated with mobile cellular telephone devices less frequently called from said first mobile cellular telephone device.

4. The method as in claim 1, comprising receiving over said data network a signal from said at least one of said plurality of identified mobile cellular telephone devices, said signal including an indication of said availability status.

5. The method as in claim 4, comprising collecting said availability status from a sensor of said at least one of said plurality of identified mobile cellular telephone devices.

6. The method as in claim 4, comprising collecting said availability status from an input of a user of said at least one of said plurality of identified mobile cellular telephone devices.

7. The method as in claim 2, comprising receiving over said data network and storing on said memory, a unique identifier used on said cellular network of each said plurality of identified mobile cellular telephone devices represented on said contact list.

8. The method as in claim 7, comprising receiving over said data network and storing on said memory a signal from said at least one of said plurality of identified mobile cellular telephone devices, said signal to not transmit said availability status to said first mobile cellular telephone device.

9. The method as in claim 1, wherein transmitting said availability status comprises transmitting an availability status selected from the group of available for a call, busy on a call, phone off, ringer off, on-silent, on-vibrate, please call, in a meeting, different time zone.

10. The method as in claim 2, comprising storing a first signal from first mobile cellular telephone device, said first signal transmitted over said data network, said first signal including an instruction to issue a second signal over said data network at a time when each of said first mobile cellular telephone device and said at least one of said plurality of identified mobile cellular telephone devices are available for a call on said cellular network.

11. The method as in claim 2, wherein said transmitting comprises, transmitting upon a signal from said first mobile cellular telephone device, said signal including an indication of a possible selection of said at least one of said plurality of identified mobile cellular telephone devices for a call on said cellular network.

12. The method as in claim 1, wherein said transmitting comprises transmitting a first availability status, and comprising, upon an occurrence of an availability status change, transmitting, over said data network, from said remote memory to said first mobile cellular telephone device, a second availability status for said at least one of said plurality of identified mobile cellular telephone devices included on said contact list.

13. A method of presenting a caller with a busy signal, comprising:
storing, on a memory of a calling cellular telephone and during a period prior to the initiation of a call from said calling telephone, an availability status of a called cellular telephone;
receiving a signal to initiate said call from said calling telephone to said called telephone;
retrieving from said memory said availability status of a called cellular telephone; and
in response to said retrieved availability status, presenting to said caller said busy signal.

14. The method as in claim 13, comprising retrieving said availability status of said called telephone over a data network during said period prior to said initiation of said call.

15. The method as in claim 13, comprising presenting said caller with an alternative medium for contacting said called telephone.

16. The method as in claim 15, wherein said alternative medium for contacting said called telephone was input to said celled telephone.

17. A system for providing availability status data for a plurality of identified mobile cellular telephone devices represented on a contact list, the system comprising:
a first mobile cellular telephone device having a contact list stored thereon;
a remote memory adapted to store an association of said first mobile cellular telephone device with at least one of said plurality of identified mobile cellular telephone devices represented on said contact list;
a data network adapted to carry signals transmitted from said remote memory to said first mobile cellular telephone device representing an availability status for said at least one of said plurality of identified mobile cellular telephone devices included on said contact list; and
a display on said first mobile cellular telephone device adapted to indicate said availability status in association with a representation on said contact list of said at least one of said plurality of identified mobile cellular telephone devices.

18. The system as in claim 17, wherein said data network is adapted to receive a signal from said at least one of said plurality of identified mobile cellular telephone devices, said signal including an indication of said availability status.

19. The system as in claim 17, wherein at least one of said plurality of identified mobile cellular telephone devices comprises a sensor adapted to detect said availability status.

20. The system as in claim 17, comprising a unique identifier for each said plurality of identified mobile cellular telephone devices represented on said contact list, said unique identifier transmitted over said data network and stored on said memory,
